(19) United States
(12) Patent Application Publication
(10) Pub. No.: US 2009/0265143 A1
(43) Pub. Date: Oct. 22, 2009

(54) VIRTUAL WIRELESS COMMUNICATION INDUSTRIAL SITE SURVEY

(75) Inventors: David R. Kaufman, Scottsdale, AZ (US); Paul F. McLaughlin, Ambler, PA (US)

Correspondence Address: Anthony Miologos;Honeywell International Inc., 101 Columbia Road, PO BOX 2245, Morristown, NJ, 07962, US

(73) Assignee: Honeywell International Inc., Morristown, NJ (US)

(21) Appl. No.: 12/106,606

(22) Filed: Apr. 21, 2008

(51) Int. Cl. G06G 7/62; G06F 17/50; G06F 17/10

(52) U.S. Cl. 703/1

(57) ABSTRACT

A method includes receiving a representation of an industrial site and selecting a plurality of locations in the representation. The method further includes predicting a level of wireless coverage of the industrial site based upon the selected locations and comparing the level of wireless coverage to a predetermined coverage criterion. Based upon a result of the comparison, the method repeats the steps of selecting, predicting and comparing.

### TECHNICAL FIELD

This disclosure relates generally to wireless communication and more specifically to a method and apparatus for preparing a virtual wireless communication site survey of an industrial site.

### BACKGROUND

Many buildings, facilities, and other structures include secure communication networks, which are used for wireless and other types of communications. For example, chemical plants and other industrial facilities often include wireless networks, which can be used for a wide variety of purposes. As particular examples, the wireless networks in industrial facilities could be used to transport data to and from process controllers, process sensors, and process actuators. The wireless networks could also facilitate wireless communications between personnel working in the industrial facilities. In still other applications, a wireless network may convey information from sensing, actuating and controlling devices to historian applications and advanced/operator/business applications.

### SUMMARY

This disclosure provides a method and apparatus for preparing a virtual wireless communication site survey of an industrial site.

In a first embodiment, a method includes receiving a representation of an industrial site and selecting a plurality of locations in the representation. The method further includes predicting a level of wireless coverage of the industrial site based upon the selected locations and comparing the level of wireless coverage to a predetermined coverage criterion. Based upon a result of the comparison, the method repeats the steps of selecting, predicting and comparing.

In a second embodiment, an apparatus includes a network interface and a processor. The processor is operable to receive a first representation of an industrial site via the network interface and select a plurality of locations in the first representation. The processor is further operable to predict a level of wireless coverage of the industrial site based upon the selected locations and compare the level of wireless coverage to a predetermined coverage criterion. Based upon a result of the comparison, the processor is operable to repeat the steps of selecting, predicting and comparing. The processor is further operable to generate at least one of a list of the selected locations, and a second representation of the industrial site, where the second representation comprises information from the first representation and a representation of the selected locations.

In a third embodiment, a system includes a database and a processor coupled to the database via a network. The processor is operable to receive a first representation of an industrial site from the database and select a plurality of locations in the first representation. The processor is further operable to predict a level of wireless coverage of the industrial site based upon the selected locations and compare the level of wireless coverage to a predetermined coverage criterion. Based upon a result of the comparison, the processor is operable to repeat the steps of selecting, predicting and comparing. The processor is further operable to generate at least one of a list of the selected locations, and a second representation of the industrial site, where the second representation comprises information from the first representation and a representation of the selected locations.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates a system for generating a virtual industrial site survey according to this disclosure;

FIG. 2 illustrates a representation of an industrial site according to this disclosure;

FIG. 3 illustrates a representation of an industrial site, a selected location, and predicted coverages based upon the location, according to this disclosure;

FIG. 4 illustrates a representation of an industrial site, two selected locations, and predicted coverages based upon the two locations, according to this disclosure; and

FIG. 5 illustrates a flowchart of a process according to this disclosure.

### DETAILED DESCRIPTION

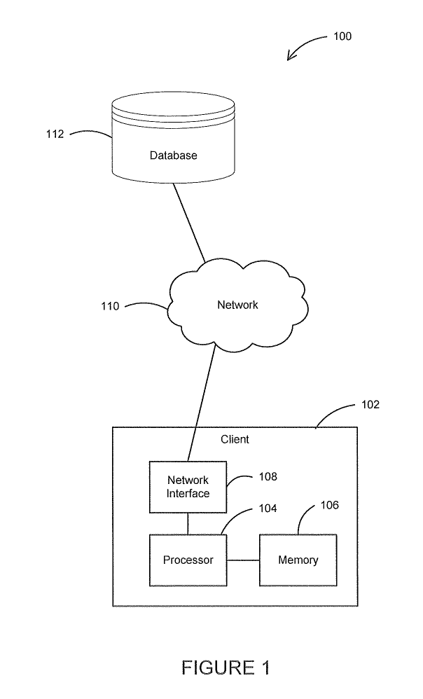

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates a system 100 for generating a virtual industrial site survey according to this disclosure. The embodiment of the system 100 shown in FIG. 1 is for illustration only. Other embodiments of the system 100 may be used without departing from the scope of this disclosure. In general, this embodiment of the system 100 comprises devices that are adapted to generate a virtual industrial site survey. Such a system enables the preparation of a wireless communication site survey without visiting the site to physically measure wireless propagation characteristics.

Wireless communication to or from almost any location in the site may be required at some time during the operational life of the site. At some point, an operator, engineer, maintenance personnel, plant supervisor or other person at the site may need to locate a wireless device for an actuator or sensor on or near any of the equipment in the site. User interface elements may need to be placed in both offices and near equipment. Therefore, prior to installing a wireless communication system in an industrial site, a site operator, engineer, a 3^{rd} party wireless expert or other person designing a wireless system for the site may want an estimate of how many wireless access points are needed to cover the site and where they should be located. In sites that already have a wireless network, an estimate may be prepared to raise signal levels, expand the area covered or fill in gaps in the current coverage of the existing network. Such estimates enable the site operator, engineer, a 3^{rd} party wireless expert or other person to gauge the cost and complexity of installing or enhancing a wireless communication system on the site.

In the system 100, a client 102 includes a processor 104, a memory 106 and a network interface 108. The processor is coupled to the memory 106, which is operable to store programs and data for use by the processor 104. The processor 104 is also coupled to the network interface 108. The processor 104 communicates with a network 110 via the network interface 108. Also coupled to the network is a database 112.

When a user of the client 102 desires to prepare a virtual industrial site survey, the user identifies an industrial site to be surveyed to the client 102. The site may be identified by name, geographic location, GPS coordinates, or other identifier.

The client 102 then obtains a representation of the indicated site from the database 112. The representation may be an aerial photograph of the site, obtained from Google Earth or another service. Additionally or alternatively, the representation may be a site plan, blueprint, or other schematic representation obtained from the site owner or manager.

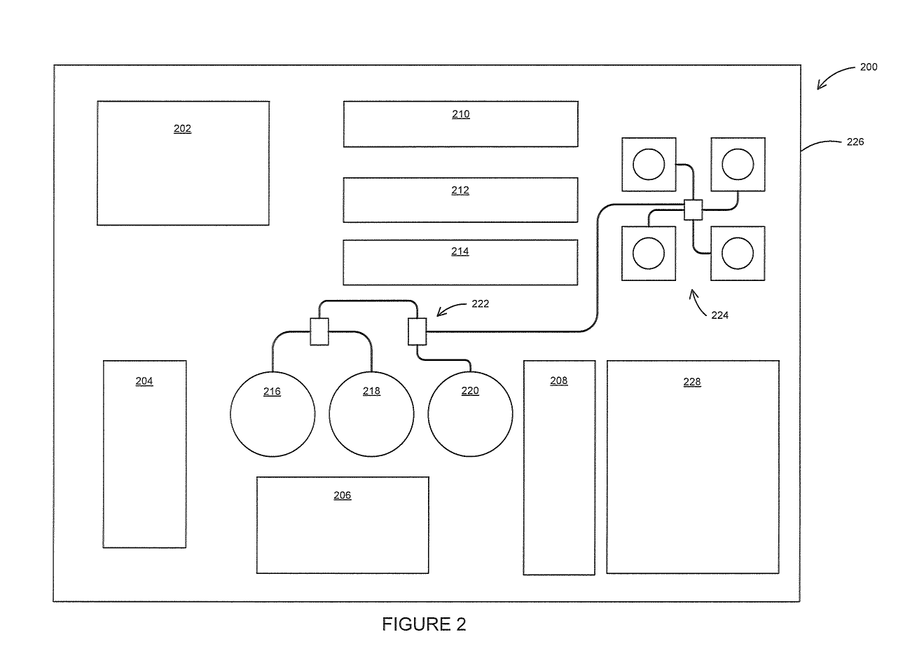

Once the client has obtained the representation of the site, the client then executes a process according to the present disclosure to prepare a virtual wireless communication site survey of the site. The process will be described in greater detail below, with reference to FIGS. 2-5.

One result of the virtual wireless communication site survey is a selected plurality of locations in the site where wireless access points may be positioned to provide a predetermined level of wireless coverage throughout the site. The criterion for the desired level of wireless coverage may be a threshold minimum signal level that is maintained everywhere within the site for wireless signals transmitted from the wireless access points. Another criterion may be a threshold minimum signal level that is maintained at a predefined plurality of locations within the site Another criterion may be a minimum transmission capacity for which any wireless device having such capacity will be able to communicate with at least one wireless access point from one or more selected locations within the site. Yet another criterion may be a measure of error rate experienced by a wireless device located at any location within the site. Another criterion may be a minimum number of wireless access points with which a wireless device may establish reliable communications from any location within the site. A composite criterion may be created by combining one or more of these and/or other criteria.

Although FIG. 1 illustrates one example of a virtual industrial site survey system, various changes may be made to FIG. 1. For example, the representation of the site may be obtained from another source than a database or may be directly loaded into the client, rather than via a network. Data required for preparing a site survey may be stored in a remote location, rather than in local memory in the client. A user interface may be provided for the client to enable the client to specify criteria or to participate in one or more steps of the process.

FIG. 2 illustrates a representation 200 of an industrial site according to this disclosure. Within a perimeter 226 are representations of several objects or structures on the site. Buildings 202, 204 and 206 house offices, machinery and/or equipment. A warehouse 208 is adjacent to a paved area 228 for trucks. Raw materials are kept in storage bins 210, 212 and 214. Tanks 216, 218 and 220 are coupled by distribution network 222 to processing columns 224.

The representation 200 is a line drawing of the objects in the industrial site. In other embodiments of the present disclosure, a photographic or other representation may be used. In each type of representation, objects and structures in an industrial site will have a characteristic appearance that enables them to be identified. Such identification may be performed automatically, for example by optical recognition software. Identification may be performed by analyzing additional data attached to a site plan. A user of a system according to the present disclosure may perform identification interactively.

Once identified, further information about each structure may be determined from the representation. The material from which the exterior of the structure is formed may be identified from a photograph. A blueprint or site plan may have information attached detailing the materials or internal structure of an object. As for structure identification, material identification may be performed automatically by the system, received along with site plan details, or performed interactively by a user of the system. Based upon size, shape, material, internal structure, and other information about objects in the site the system of the present disclosure predicts a characteristic interference and/or degradation that objects in the actual site will cause in wireless signals propagated in the site.

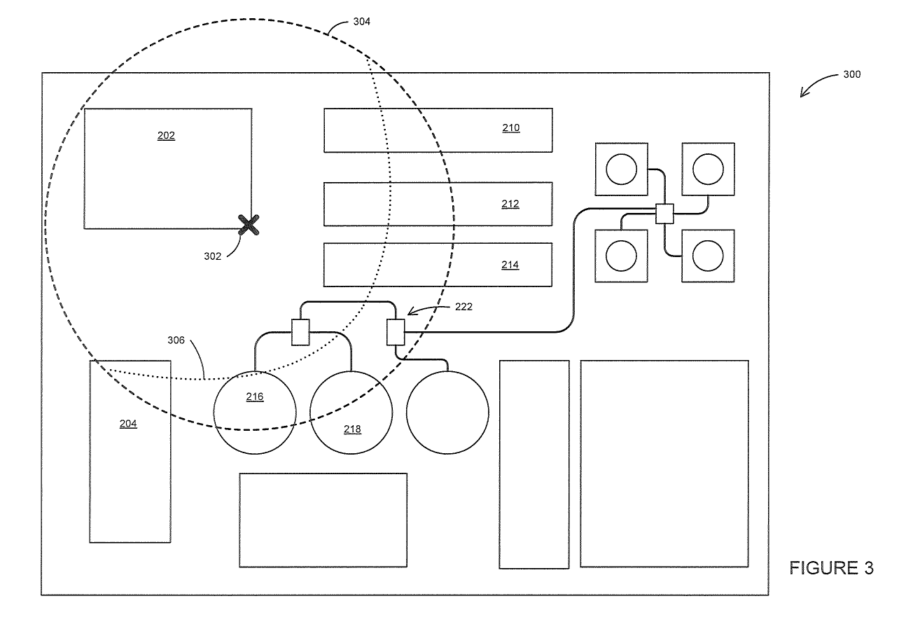

FIG. 3 illustrates a representation 300 of an industrial site, a selected location 302, and predicted coverages based upon the location 302, according to this disclosure. Underlying the representation 300 is the representation 200 of the site from FIG. 2. The location 302 is at a corner of the building 202. The location 302 may be chosen according to a heuristic that takes into account factors such as a location's accessibility to power and wired signal distribution and the ease of accessing and attaching an antenna or other equipment to a structure.

Based upon a height and sensitivity of a proposed antenna placed at the location 302, as well as wireless characteristics of the access point, the system according to the present disclosure predicts an ‘ideal’ wireless coverage in the site corresponding to the representation 200. The system then determines that, absent interference from other structures in the site, a predetermined coverage criterion would be met within the ‘ideal’ area indicated by a contour 304. As described above, the coverage criterion may be signal strength of a transmitted signal, received signal strength from a wireless device having a transmitter capacity above a predetermined limit, communications error rate, or other criterion.

Subsequently, the system applies previously calculated interference and/or degradation characterizations of objects within the ‘ideal’ contour 304 to the prediction of wireless coverage from the location 302. The system may also apply signal degradation factors for potential atmospheric factors, such as rain or fog, in order to calculate coverage at times when such factors are present. The resulting prediction indicates that because of the effects of the objects and/or atmospheric factors, the coverage criterion will only be met within the reduced area of a contour 306. While the building 202 will affect the signal, all locations within the building 202 still meet the criterion. However, the contour 306 does not extend as far from the location 302 as does the contour 304 because of the effects of the storage bins 210, 212 and 214, the tanks 216 and 218, and the building 204. The contour 306 represents the system prediction from the representation 200 of the area within the actual site in which the desired coverage criterion would be met, were a wireless access point to be installed at the physical location corresponding to the location 302 in the representation.

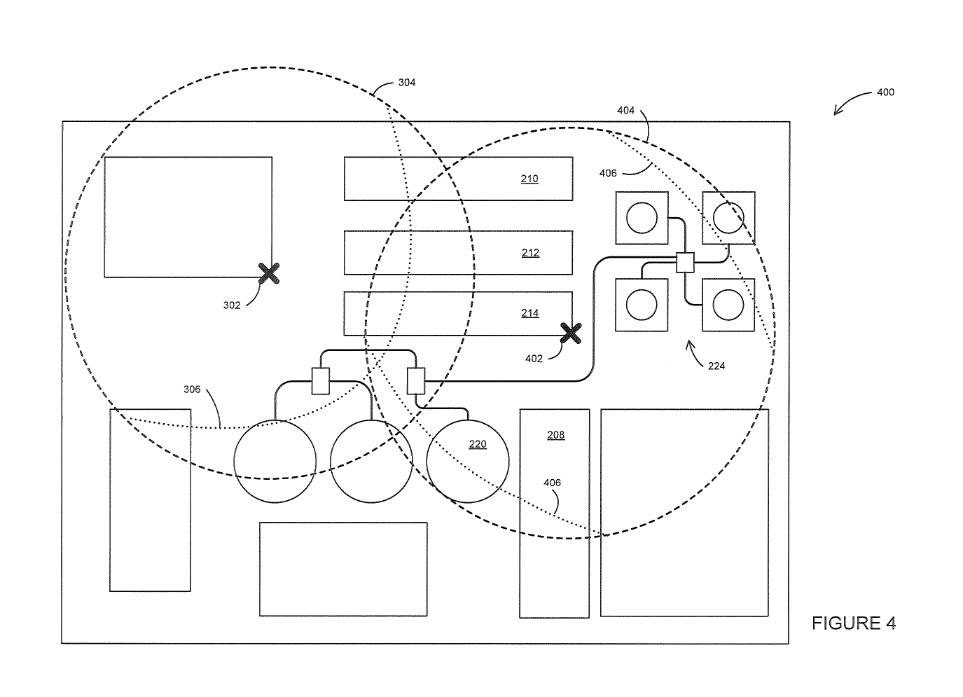

FIG. 4 illustrates a representation 400 of an industrial site, selected locations 302 and 402, and predicted coverages based upon the locations 302 and 402, according to this disclosure. The location 402 is at a corner of the storage bin 214. The location 402 may be chosen according to a heuristic that takes into account factors such as those described with regard to the selection of the location 302, as well as the area of the site already covered by contour 306.

As was done for the location 302, the system according to the present disclosure predicts an area covered by an access point at location 402 in the absence of any interference or degradation, indicated by ‘ideal’ contour 404. The system then applies expected interference and/or degradation resulting from structures 224, 208 and 220 and/or atmospheric factors to predict an actual coverage area, indicated by contour 406.

The system predictions of coverage from locations 302 and 402 may be combined by forming the union of the contours 306 and 406. An area of the site within the merged contours will meet or exceed the desired coverage criterion. The process includes selecting a location based upon the structures of the site and the coverage already achieved with previously selected locations, predicting an ‘ideal’ coverage and a degraded coverage, and combining the degraded coverage with coverages from previously selected locations. Once the combined coverages adequately serve all areas of interest in the site, iteration of the process ceases.

Once the process of selecting locations and predicting their coverages has completed, the system may generate a list of the selected locations. Furthermore, the system may generate a representation such as that in FIG. 4, showing the site representation, the selected locations, and the combined predicted coverage from the locations. Additional information about the wireless access points modeled at the selected locations—such as antenna height and type, transmitter power, and receiver sensitivity—may be provided along with either the list or the representation.

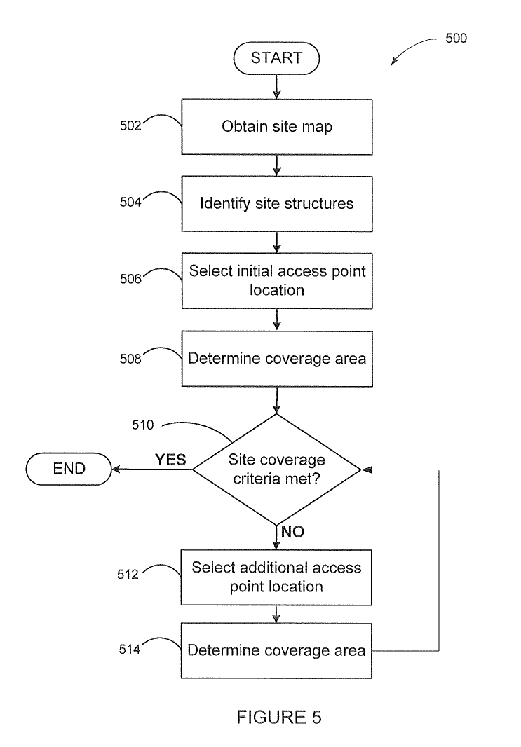

FIG. 5 illustrates a flowchart of a process 500 according to this disclosure. The process 500 begins in step 502 with obtaining a site map, photograph, or other representation of an industrial site. In step 504, the representation obtained in step 502 is used to identify site structures and objects and to estimate effects of the structures and objects on wireless communication within the site. A first location is chosen in step 506, for example by selecting for estimated best height, access to power, mounting option, access for maintenance, and/or initial wireless coverage area. In step 508, a coverage area for a wireless access point placed at the first location is predicted. In step 510, coverage of the site is compared to one or more site coverage criteria and, if satisfactory, the process is ended.

If coverage of the site does not meet the criteria in step 510, then an additional location is selected in step 512, for example by selecting for estimated next best height, access to power, mounting option, access for maintenance, and/or wireless coverage area adjacent to the first location. In step 514, a coverage area for a wireless access point placed at the additional location is predicted and combined with coverage areas for any other previously chosen locations. The process then returns to step 510 to compare the combined coverage areas to the one or more site coverage criteria. Steps 510, 512 and 514 are repeated until the one or more site coverage criteria are met, whereupon the process ends.

It may be advantageous to set forth definitions of certain words and phrases used throughout this patent document. The term “couple” and its derivatives refer to any direct or indirect communication between two or more elements, whether or not those elements are in physical contact with one another. The terms “over,” “above,” and the like denote relative positions of two or more elements in a particular orientation and do not require direct contact between the elements. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising the steps of:
receiving a representation of an industrial site;
selecting a plurality of locations in the representation of the industrial site;
predicting a level of wireless coverage of the industrial site based upon the selected locations in the representation;
comparing the level of wireless coverage to a predetermined coverage criterion; and
repeating the steps of selecting, predicting and comparing based upon a result of the comparison.

2. The method of claim 1, wherein receiving a representation of an industrial site comprises identifying representations of objects in the industrial site that affect wireless coverage.

3. The method of claim 2, wherein predicting a level of wireless coverage of the industrial site based upon the selected locations in the representation comprises:
predicting a first wireless coverage from a first of the plurality of locations;
predicting a second wireless coverage from the first location based upon a predicted effect of one or more of the objects on the first coverage; and
combining the second coverage with predicted coverages from one or more other locations of the plurality of locations.

4. The method of claim 1, wherein selecting a plurality of locations in the industrial site comprises:
selecting a first location;
predicting a level of wireless coverage of the industrial site based upon the first location;
selecting one or more other locations of the plurality of locations according to a result of the prediction based upon the first location.

5. The method of claim 1, wherein predicting a level of wireless coverage of the industrial site based upon the selected locations comprises:
predicting a level of wireless coverage based upon each of the plurality of the selected locations in the representation; and
combining the predicted coverages.

6. The method of claim 1, wherein comparing the level of wireless coverage to a predetermined coverage criterion comprises:
selecting a second plurality of locations in the representation of the industrial site;
determining from the predicted level of wireless coverage of the industrial site a predicted level of wireless coverage at each of the second plurality of locations; and
comparing the predicted level of wireless coverage at each of the second plurality of locations to a predetermined level of wireless coverage.

7. The method of claim 1, wherein predicting a level of wireless coverage of the industrial site based upon the selected locations in the representation comprises at least one of:
predicting a signal strength in the industrial location of a wireless signal transmitted from at least one of the selected locations; and
predicting, for at least one of the selected locations, a signal strength of a wireless signal received from each of a second plurality of locations in the representation.

8. The method of claim 1, wherein:
the representation of an industrial site comprises information relating to one or more pre-existing locations; and
predicting a level of wireless coverage of the industrial site comprises predicting a level of wireless coverage based upon the selected locations and the one or more pre-existing locations.

9. An apparatus comprising:
a network interface; and
a processor operable to:
receive a first representation of an industrial site via the network interface;
select a plurality of locations in the first representation of the industrial site;
predict a level of wireless coverage of the industrial site based upon the selected locations in the first representation;
compare the level of wireless coverage to a predetermined coverage criterion;
repeat the steps of selecting, predicting and comparing based upon a result of the comparison; and
generate at least one of:
a list of the selected locations, and
a second representation of the industrial site comprising information from the first representation and a representation of the selected locations.

10. The apparatus of claim 9, wherein the processor is further operable to identify representations of objects in the industrial site that affect wireless coverage.

11. The apparatus of claim 10, wherein the processor is further operable to predict a level of wireless coverage of the industrial site based upon the selected locations in the representation by:
predicting a first wireless coverage from a first of the plurality of locations;
predicting a second wireless coverage from the first location based upon a predicted effect of one or more of the objects on the first coverage; and
combining the second coverage with predicted coverages from one or more other locations of the plurality of locations.

12. The apparatus of claim 9, wherein the processor is further operable to select a plurality of locations in the industrial site by:
selecting a first location;
predicting a level of wireless coverage of the industrial site based upon the first location;
selecting one or more other locations of the plurality of locations according to a result of the prediction based upon the first location.

13. The apparatus of claim 9, wherein the processor is further operable to predict a level of wireless coverage of the industrial site based upon the selected locations by:
predicting a level of wireless coverage based upon each of the plurality of the selected locations in the representation; and
combining the predicted coverages.

14. The apparatus of claim 9, wherein the processor is further operable to compare the level of wireless coverage to a predetermined coverage criterion by:
selecting a second plurality of locations in the representation of the industrial site;
determining from the predicted level of wireless coverage of the industrial site a predicted level of wireless coverage at each of the second plurality of locations; and
comparing the predicted level of wireless coverage at each of the second plurality of locations to a predetermined level of wireless coverage.

15. The apparatus of claim 9, wherein the processor is further operable to predict a level of wireless coverage of the industrial site based upon the selected locations in the representation by at least one of:
predicting a signal strength in the industrial location of a wireless signal transmitted from at least one of the selected locations; and
predicting, for at least one of the selected locations, a signal strength of a wireless signal received from each of a second plurality of locations in the representation.

16. A system comprising:
a database; and
a processor coupled to the database via a network, the processor operable to:
receive a first representation of an industrial site from the database;
select a plurality of locations in the first representation of the industrial site;
predict a level of wireless coverage of the industrial site based upon the selected locations in the first representation;
compare the level of wireless coverage to a predetermined coverage criterion;
repeat the steps of selecting, predicting and comparing based upon a result of the comparison; and
generate at least one of:
a list of the selected locations, and
a second representation of the industrial site comprising information from the first representation and a representation of the selected locations.

17. The apparatus of claim 16, wherein the processor is further operable to:
identify representations of objects in the industrial site that affect wireless coverage; and
predict a level of wireless coverage of the industrial site based upon the selected locations in the representation by:
predicting a first wireless coverage from a first of the plurality of locations;
predicting a second wireless coverage from the first location based upon a predicted effect of one or more of the objects on the first coverage; and
combining the second coverage with predicted coverages from one or more other locations of the plurality of locations.

18. The apparatus of claim 16, wherein the processor is further operable to select a plurality of locations in the industrial site by:
selecting a first location;
predicting a level of wireless coverage of the industrial site based upon the first location;
selecting one or more other locations of the plurality of locations according to a result of the prediction based upon the first location.

19. The apparatus of claim 16, wherein the processor is further operable to predict a level of wireless coverage of the industrial site based upon the selected locations by:
predicting a level of wireless coverage based upon each of the plurality of the selected locations in the representation; and
combining the predicted coverages.

20. The apparatus of claim 16, wherein the processor is further operable to compare the level of wireless coverage to a predetermined coverage criterion by:
selecting a second plurality of locations in the representation of the industrial site;
determining from the predicted level of wireless coverage of the industrial site a predicted level of wireless coverage at each of the second plurality of locations; and
comparing the predicted level of wireless coverage at each of the second plurality of locations to a predetermined level of wireless coverage.

21. The apparatus of claim 16, wherein the processor is further operable to predict a level of wireless coverage of the industrial site based upon the selected locations in the representation by at least one of:
predicting a signal strength in the industrial location of a wireless signal transmitted from at least one of the selected locations; and
predicting, for at least one of the selected locations, a signal strength of a wireless signal received from each of a second plurality of locations in the representation.
